(19) United States
(12) Patent Application Publication
(10) Pub. No.: US 2013/0187940 A1
(43) Pub. Date: Jul. 25, 2013

(54) SYSTEM AND METHOD FOR EDITING, OPTIMIZING, AND RENDERING PROCEDURAL TEXTURES

(71) Applicants: Cyrille Damez, Clermont-Ferrand (FR); Christophe Soum, Clermont-Ferrand (FR)

(72) Inventors: Cyrille Damez, Clermont-Ferrand (FR); Christophe Soum, Clermont-Ferrand (FR)

(73) Assignee: ALLEGORITHMIC SAS, Clermont-Ferrand (FR)

(21) Appl. No.: 13/812,293

(22) PCT Filed: Jul. 29, 2011
(86) PCT No.: PCT/IB2011/001753

§ 371 Date: Apr. 1, 2013

Related U.S. Application Data
(60) Provisional application No. 61/369,810, filed on Aug. 2, 2010.

(30) Foreign Application Priority Data
Jul. 30, 2010 (FR) 1003204

(51) Int. Cl. G06T 11/00

(52) U.S. Cl. CPC G06T 11/001
USPC 345/582

(57) ABSTRACT

A system for editing and generating procedural textures includes at least one microprocessor, a memory and a list of instructions allowing procedural textures in a procedural format to be edited, and, based on the edited procedural data, generating textures in a raster format. The system provides an editing tool for creating or modifying textures in a procedural format, an optimization device, provided with a linearization module, a parameter-effect tracking module and a graph data module, for storing graph data in an optimized procedural format, and a rendering engine, adapted to generate raster textures. Corresponding editing and generation methods are also provided.

### CROSS-REFERENCE TO RELATED APPLICATION(S)

This is a National Stage Entry into the United States Patent and Trademark Office from International PCT Patent Application No. PCT/IB2011/001753, having an international filing date of 29 Jul. 2011, which claims priority to French Patent Application No. 1003204, filed 30 Jul. 2010, and U.S. Patent Application No. 61/369,810, filed 2 Aug. 2010, the contents of all of which are incorporated herein by reference.

### TECHNICAL FIELD OF THE INVENTION

The present invention relates to a system for editing and generating procedural textures allowing procedural textures in a procedural format to be edited, and based on the edited procedural data, allowing textures to be generated in a raster format. It relates more particularly to corresponding editing and generating methods.

### STATE OF THE ART

Many graphics applications need to handle significant amounts of data leading to the use of significant memory space and whose handling requires a large number of complex computations. In addition, certain types of interactive graphical applications must minimize their response time as much as possible to provide satisfactory user experience: video games, training simulators, video editing or compositing software. These applications devote a significant proportion of resources to the handling of images known as “textures”, which for instance represent the surface appearance of an object, background scenery, or composition masks. The textures are used to store not only color information, but also any other parameter useful to the application. In a video game, textures typically store colors, small surface features, as well as the reflection coefficients of materials.

Editing, storing and displaying these textures are key issues for graphics applications. Generally, the textures are painted by graphics designers, and are sometimes based on photographs. Once painted, the texture has a frozen resolution and it is very difficult to adapt it to another context. As applications increasingly use textures, it becomes very expensive to hand paint a sufficient quantity of different textures and it is not uncommon to see repetition on the screen. Furthermore, textures are stored as arrays of pixels (color dots), which will hereinafter be referred to as “bitmaps”. Even after it has been compressed, such information is very costly to store on a mass medium such as a DVD or a hard disk, and very slow to transfer over a network.

Of course, techniques have been proposed to meet these challenges, in particular the concept of a procedural texture. According to this approach the image results from a computation rather than hand painting. Under certain conditions, the computation of the image can be made at the last moment, just before it is displayed, thus reducing the need to store the entire image. It is also easy to introduce changes in procedural textures, thus avoiding repetition. However, procedural textures cannot be easily created and manipulated by graphics designers, and their use remains restricted to a small number of specific types of material. Despite numerous attempts, no system has been able to provide a comprehensive tool for efficiently editing, manipulating and displaying procedural textures.

To overcome these drawbacks, the invention provides various technical means.

### SUMMARY OF THE INVENTION

A first object of the invention is to provide a device for editing and generating textures for use with applications in which rendering must be performed in a very short time, or even in real time.

Another object of the invention is to provide an editing method for use with applications in which rendering must be performed in a very short time or even in real time.

Another object of the invention is to provide a method for rendering textures for use with applications in which rendering must be performed in a very short time or even in real time.

To this end, the invention provides a system for editing and generating procedural textures comprising at least one microprocessor, a memory and a list of instructions, and for editing procedural textures in a procedural format, and, based on the edited procedural data, generating textures in a raster format, and further comprising:
an editing tool, adapted to provide a user interface for creating or modifying textures in a procedural format;
an optimization device, provided with a linearization module, a parameter-effect tracking module and a graph data module, for storing graph data in an optimized procedural format;
a rendering engine, adapted to generate raster textures based on the graph data in an optimized procedural format and comprising a parameter list traversal module M0, a filter execution module M1, a parameter evaluation module M2 and a filter module, comprising the data to be executed for each of the filters.

The invention addresses all of the problems raised by providing a comprehensive processing chain, ranging from editing to generation, for displaying procedural textures. The editing tool promotes the reuse of existing image chunks and can generate an infinite number of variations of a basic texture. The tool does not store the final image, but rather a description of the image, that is, the successive steps which allow it to be computed. In the vast majority of cases, this description is much smaller in size than the “bitmap” image. In addition, the technology according to the invention has been designed to allow rapid generation of “bitmap” images based on their descriptions. The descriptions derived from the editor are prepared using a component known as the optimizer, to accelerate their generation when compared to the use of a naive strategy. Applications need only to know these reworked descriptions. When the application intends to use a texture, it requests the generation component, known as the rendering engine, to convert the reworked description into a “bitmap” image. The “bitmap” image is then used as a conventional image. In this sense, the technology according to the present invention is minimally invasive, since it is very simple to interface with an existing application.

Advantageously, the filters include data and mathematical operators.

According to another aspect, the invention also provides an optimization device comprising at least one microprocessor, a memory and a list of instructions, and further comprising:
a linearization module;
a parameter tracking module;
a graph data module “D”.

Such an optimization device is advantageously integrated into a device for editing procedural textures. In an alternative embodiment, it is integrated into a rendering engine. In yet another embodiment, it is integrated into a third party application.

According to yet another aspect, the invention provides a rendering engine for rendering textures or images in a procedural format comprising at least one microprocessor, a memory and a list of instructions, and further comprising:
a list traversal module M0 for traversing a list of the processes to be performed;
a filter execution module M1;
a parameter evaluation module M2;
a filter module, which includes the data to be executed for each of the filters.

Advantageously, the engine for rendering textures in a procedural format is integrated within an application which includes at least one image generation phase, wherein said generation is performed based on graph data in an optimized procedural format.

According to another aspect, the invention provides a method for editing procedural textures for a texture generation and editing system, comprising the steps of:
generating the graph data in a procedural format, using an editing tool;
optimizing the generated data into graph data in an optimized procedural format, using an optimization device.

According to yet another aspect, the invention provides a method for generating procedural textures for a rendering engine, comprising, for each filter involved, the steps of:
traversing the list of graph data in an optimized procedural format;
reading, from the graph data in a procedural optimized format, the parameters used for the computation performed for the fixed parameter values;
evaluating the user functions for computing the value of the non-fixed parameters;
recovering the memory locations of the intermediate results to be consumed in the computation of the current node;
performing the computation of the current data for graphs in an optimized procedural format for determining corresponding raster data;
storing the result image into memory; and,
   when all of the filters involved have been processed, making the generated raster texture available to the host application.

### DESCRIPTION OF THE FIGURES

All implementation details are given in the following description, with reference to FIGS. 1 to 10, presented solely for the purpose of non-limiting examples and in which:

FIGS. 1a and 1b illustrate the main steps related to the editing, optimization and generation or rendering of textures according to the invention;

FIG. 2 shows an example of the wrapping of a subgraph and re-displaying of certain parameters;

FIG. 3 shows an example of texture compositing using a mask;

FIG. 4 shows an example of transformation of an editing graph into a list;

FIG. 5 shows an example of a device that implements the editing tool according to the invention;

FIG. 6 shows an example of interaction and data management from the editing tool;

FIG. 7 shows an example of an optimizer according to the invention;

FIG. 8 shows an example of a device implementing a rendering engine according to the invention;

FIG. 9 shows an example of list traversal used by the rendering engine; and

FIG. 10 shows an example of a procedural graph edited by an editing system according to the invention.

### DETAILED DESCRIPTION OF THE INVENTION

The proposed invention represents images in the form of a graph. Each node in the graph applies an operation, or a filter, to one or more input images (blur, distortion, color change, etc.) to produce one or more output images. Each node has parameters that can be manipulated by the user (intensity, color, random input, etc.). The graph itself also has a number of parameters that can be manipulated by the user, which affect all of the output images of the graph. Parameters specific to the filters or common to the entire graph can themselves be controlled by other parameters via user-defined arithmetic expressions. Certain nodes generate images directly from their parameters without “consuming” any input image. During graph execution, these are usually the nodes that are the first to be computed, thereby providing the starting images that will gradually be reworked to produce the output image.

The edit graph is a directed acyclic graph (DAG) consisting of three kinds of node, the “input”, “composition”, and “output” nodes:
the nodes of “input” type are optional and are used to design a filter on existing images supplied to the generator at the time of computation;
the composition nodes encode atomic operations using zero, one or more nodes as input.
   Each composition node is an instance of an atomic type of predetermined filtering operation. All types of atomic operations are known and implemented by the generator;
the output nodes define the computation results which the user wishes to obtain.

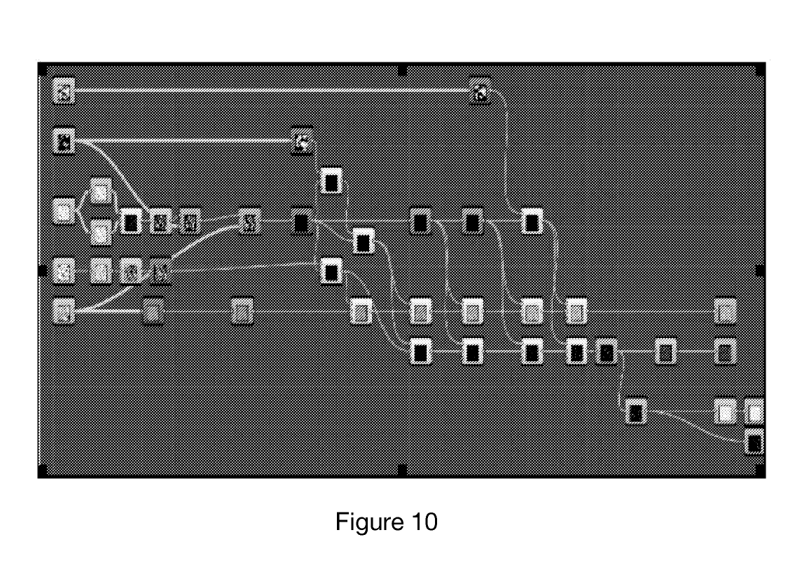

An example of a graph obeying this structure is given in FIG. 10. In this figure, the following can be identified:
the five input nodes, which take no input image and which generate the images used by downstream filters;
the four output nodes, which do not provide an intermediate image intended for other filters, but rather the images resulting from the graph and intended for the host application;
the intermediate nodes, which consume one or several intermediate images, and generate one or several intermediate images.

The consumed and generated images can be of two different types: color images using RGBA (red/green/blue/opacity) channels or black and white images, which store only one luminance channel. The inputs of the composition nodes represent the images used by the atomic operation: their number and the number of channels of each are determined by the type of atomic operation. Composition nodes have one (or more) output(s), which represent(s) the image resulting from the operation and has (have) a number of channels determined by the type of atomic operation.

The outputs of the composition nodes and input nodes can be connected to any number of inputs of the compositing or output nodes. An input can be connected only to a single output. An edge is valid only if it does not create a cycle in the graph, and if the number of input channels is equal to that of the output.

The definition of “grammar” used by the graph and the selection of filters is that of essential elements that determine, on the one hand the complexity and efficiency of the generation process, and on the other hand the expressiveness of the technology itself, and therefore the variety of results that can be produced.

The filters are classified into four main categories:
“Impulse”: “impulse” filters arrange many texture elements at different scales and in patterns directly programmable by the user.
“Vector”: “vector” filters generate images based on a compact vector representation, such as polygons or curves (possibly colored).
“Raster”: “raster” filters work directly on pixels. These filters perform operations such as distortion, blurring, color changes, image transformation (rotation, scaling, . . . ).
“Dynamic”: “dynamic” filters can receive images created by the calling application, in vector or “bitmap” form (e.g. from the “frame buffer” of the graphics card), in such a way that a series of processes can be applied to them, leading to their modification.

The ability to use all of these complementary types of filter is particularly advantageous because it provides unlimited possible uses at a minimal cost. The list of the filters used is implementation-independent and can be specialized for the production of textures of a particular type.

Editing graphs that represent descriptions of images generated by the algorithmic processing of input images (which already exist or are generated mathematically themselves) is not necessarily straightforward for the graphics designer. Therefore, it is necessary to distinguish the process of creating the basic elements from the process of assembling and parameterizing these elements in order to create textures or varieties of textures.

At the lowest level of abstraction, it should be possible to build graphs from the filters in order to set up generic processing groups. Assembling filters and changing the value of their parameters will allow the user to create reusable blocks that can be used to produce a wide variety of effects or basic patterns. In addition, it should be possible to permanently set the value of certain parameters, or otherwise make them “programmable”. The programmable parameters are those parameters whose value is generated from other parameters by a user-programmed function using standard mathematical functions. Finally, it should be possible to wrap the thus assembled graph and decide which parameters should be exposed to the end user.

At an intermediate level, the user must assemble the elements prepared in the previous step into different layers and thus compose a complete material. In addition, it must be possible, using masks, to specify which portions of the thus defined material should be affected by certain effects or parameters, in order to locate such variations. The parameters for the previously prepared elements may be related in order to change the different layers of a single material as a function of a single user input. For a given texture, it is the latter parameters which allow the result image to be varied in a given thematic field. These parameters are then displayed with a significance which relates to the texture field, such as the number of bricks in one direction or another for a brick wall texture.

Finally, at a high level of abstraction, it should be possible to generate different varieties of the same texture in order to populate a given thematic area. It is also possible to refine the final result by applying various post-processing, such as colorimetric, operations.

It is important to note that the editor produces only one generation graph containing all of the resulting textures. As described below, this maximizes resource reuse. It is also important to note that the editor manipulates the same data set (graph and parameters) in these different modes. Only the different ways in which data is displayed and the possibilities for interaction and modification of this data are affected by the current operating mode.

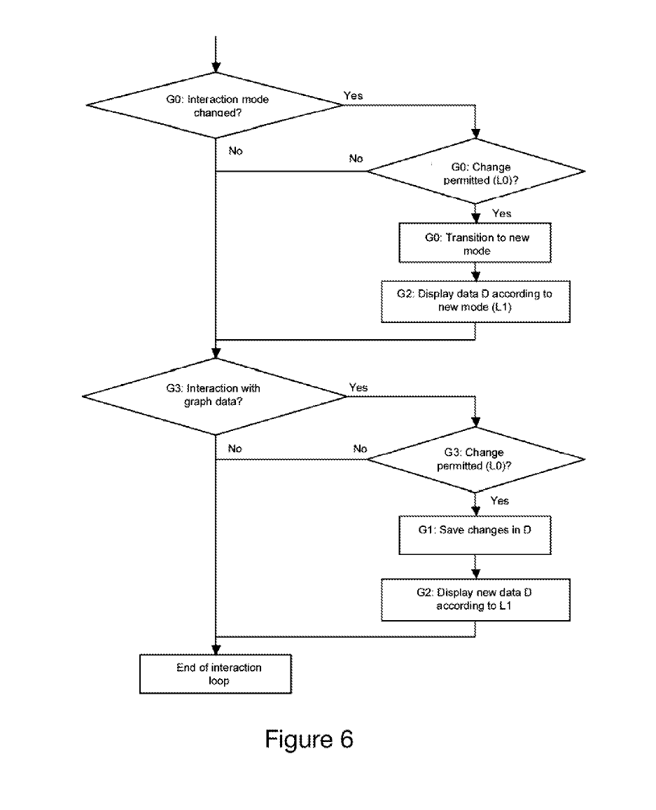

The graph texture can be directly used by the image generator engine (see FIG. 6), which would traverse it in the order of the operations (topological order). Each node would thus generate the one or more images required by subsequent nodes, until the nodes that produce the output images are reached. However, this approach would prove inefficient in terms of memory consumption. Indeed, several traversal orders are generally possible through the graph, some using more memory than others because of the number of intermediate results to be stored prior to the computation of the nodes consuming multiple inputs. It is also possible to accelerate the generation of result images if a priori knowledge about its progress is available. It is therefore necessary to perform a step of preparing the editing graph in order to create a representation, which the rendering engine can consume more rapidly than the unprepared representation.

This component is responsible for the rewriting of the graph in the form of a list, the traversal of which is trivial for the rendering engine. This list should be ordered so as to minimize memory usage when generating the result images. In addition, optimization operations are required in order to provide the rendering engine with the smallest representation able to generate the result images:
optimization of the functions used to set the value of certain parameters based on values of a set of other parameters;
removal of the non-connected or inactive graph portions based on the value of parameters which have a known value during the preparation process;
identification of the accuracy with which the filter computations must be performed to preserve the relevance of their results and to avoid introducing any conspicuous error, in accordance with a configurable threshold;
identification and indication of dependencies between the parameters displayed to the user and the output images affected by these parameters;
identification of those areas of the input images which are used by the composition nodes, so as to generate only those image portions that are indeed finally used by the output images.

Once this process has been carried out, the generation of images requires no other computations than the useful processing performed in each node. Complexity is thus shifted to the preparation process rather than to the generation of images. This allows the images to be generated rapidly, especially in situations where the constraints of time and memory usage are very high, such as when images are used as textures in a video game.

The proposed invention stores the images not in the form of pixel arrays whose color or light intensity would be noted, but in the form of ordered descriptions of the computations to be performed, and of the parameters influencing the course of these computations, in order to produce the result image. These descriptions are derived from graphs which describe the sources used (noise, computed patterns, already existing images), and the compositing computations which combine these sources in order to create intermediate images and finally the output images desired by the user. Most often, the constraint the rendering engine must satisfy is that of the time needed to generate the result images. Indeed, when a host application needs to use an image described in the form of a reworked graph, it needs to have this image as rapidly as possible. A second criterion is the maximum memory consumption during the generation process.

It has been explained in the foregoing that user-manipulated editing graphs are reworked by a specific component in order to meet, as far as possible, the two aforementioned constraints. Indeed, it is necessary to minimize the complexity of the rendering engine in order to accelerate its execution. Once a description in a linearized graph form has been made available to the rendering engine, the latter will perform the computations in the order indicated by the graph preparation component, within the constraints associated with the storage of temporary results that the component preparation has inserted into the list of computations, in order to ensure the correctness of the computation of the nodes which consume more than one input.

This rendering engine is naturally part of the editing tool, which should give users a visual rendering of the manipulations that they are performing, but can also be embedded within separate applications, which can reproduce the result images using only reworked description files.

The set of filters according to the invention results from a delicate tradeoff between ease of editing and storage and generation efficiency. One possible implementation of the proposed invention is described below. The “impulse”, “vector” and “dynamic” categories each contain a highly generic filter, namely the “FXMaps”, “Vector Graphics” and “Dynamic Bitmap Input” filters, respectively. Only the “raster” category contains several more specialized filters, whose list is as follows: Uniform Color, Blend, HSL, Channels Shuffle, Gradient Map, Grayscale Conversion, Levels, Emboss, Blur, Motion Blur, Directional Motion Blur, Warp, Directional Warp, Sharpen, 2D Transformation.

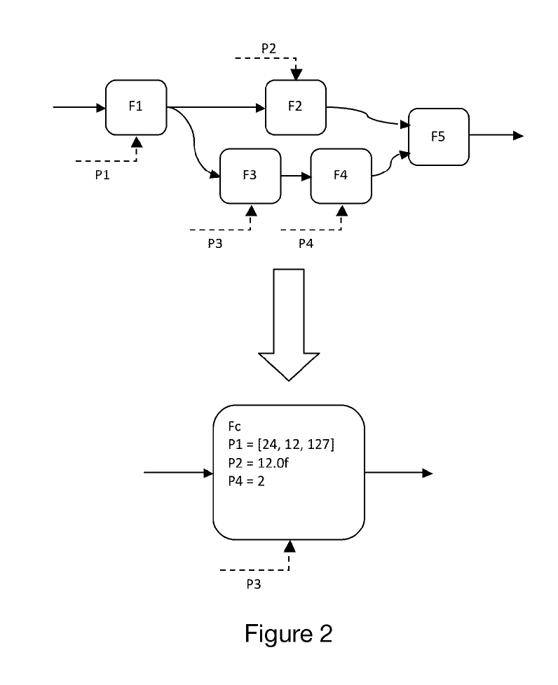

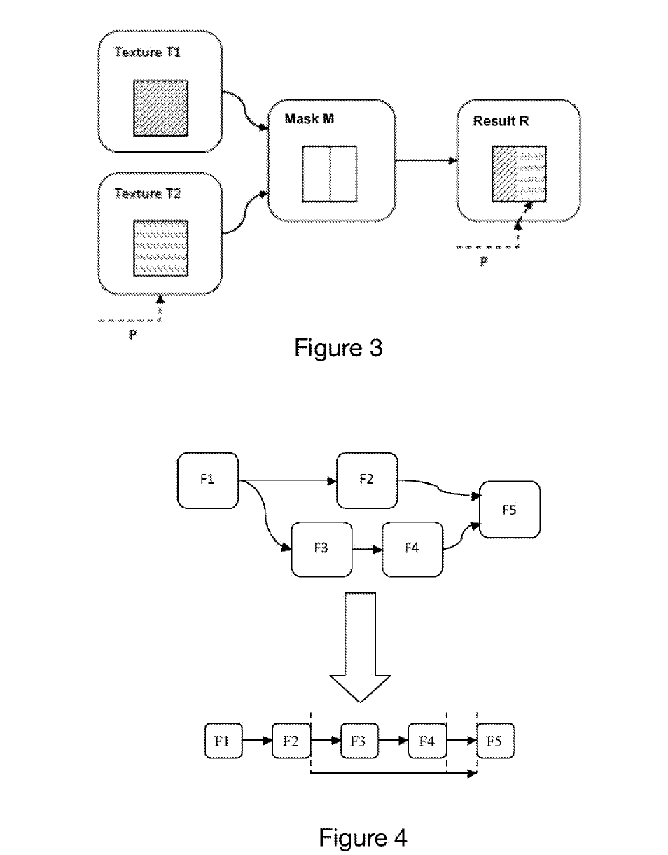

The editing tool provided by the present invention exhibits three levels of use intended for three different audiences:
A technical editing mode: in this mode, the editing tool allows generic texture graphs to be prepared, which are reusable and configurable by directly manipulating the graph, the filters and their parameters. When a group of filters achieves the desired processing, the editor allows the entire graph or a subset of that graph to be presented in the form of filters with new sets of parameters. For example, it will generate uniform material textures or basic patterns. The parameters for each block (original filter or filter set) are all available for editing. During assembly of a sub-graph for reuse, it is possible to set the value of certain parameters or on the contrary to expose them to the user. Re-exposure of the generated parameters is shown in FIG. 2. In this figure, the graph containing the filters F1 to F5 controlled by parameters P1 to P4 is reduced and presented as a composite filter, Fc. The values of the parameters P1, P2 and P4 have been set to their final values (a color, a floating number and an integer), and parameter P3 is re-exposed to the user.
A texture editing mode: in this mode, the editing tool makes it possible to create the final textures (result images), using blocks prepared in the technical edit mode, and combines these by means of filters. It prepares high-level parameters that are easily manipulated by a non-expert (size of bricks in a wall, aging coefficient of a paint, etc.). The specialized user interface for this mode also allows masks to be drawn simply, showing which portions of the final texture will be composed of a given material. An overlay stack mechanism also permits handling of the various layers of materials of which the texture is composed in order to locate certain types of processing or certain variations. An example of a masking operation based on two graphs-textures and a user-designed mask is given in FIG. 3. In this example, only texture T2 is affected by parameter P. After compositing textures T1 and T2 using mask M, only that portion of result R which is derived from T2 is affected by parameter P.
A setting and backup mode: in this mode, the editing tool allows high-level parameters to be manipulated in order to apply the textures within their surroundings. It does not create any new texture description, but merely changes its parameters to produce the variation that suits the user. The editor's user interface, which is specialized for this mode, is simplified to the extreme, thus permitting fine tuning of the high-level parameters of the textures created by the previous modes, and possibly finalizing the texture by means of a few simple post-processing operations (colorimetric settings, sharpness, etc.).

The invention also introduces a new component, the optimizer, which transforms the generation graph and performs a number of manipulations to prepare, facilitate and accelerate the generation of the result images by the rendering engine:
Graph linearization: the edit graph is transformed into a linear list in order to minimize the complexity of the image generation process. This linearization process takes into account the memory constraints associated with the generation process, and is based on the comparison of various topological sorts of the graph that are generated randomly. The criteria used to compare these topological sorts is the maximum memory usage during generation, which the comparison algorithm will try to minimize. An example of this graph linearization process is depicted in FIG. 4.
Removal of the non-connected or inactive portions of the graph. The nodes present in the editing graph but whose outputs are not connected to branches that generate the result images of the graph are not taken into account during graph transformation. Similarly, a branch of the graph leading to an intermediate result which does not contribute to the output images of the graph will be ignored during graph transformation. This second situation can occur when compositing two intermediate images with a degenerate mask which reveals only one of the two images (thereby allowing the other one, as well as the branch of the graph leading to it, to be ignored), or during a colorimetric transformation with degenerate parameters, such as zero opacity for example.
Identification of potentially compactable filter successions into a single filter. Thus, two rotations performed sequentially with different angles may be replaced by a single rotation of an angle equal to the sum of the angles of the two existing rotations. This identification and simplification of the graph can reduce the number of filters to be computed during generation and thus reduce the duration of the generation process.
Evaluation of the accuracy with which certain nodes should be computed so as not to introduce any visually perceptible error, or in order to minimize such an error. For filters that can be computed with integers instead of floating point numbers, the optimizer can evaluate the error that would be introduced by this computation method, and decide which filter variant should be preferred. Integers are often faster to handle than floating point numbers, but can introduce a loss of accuracy in the computation results. Similarly, there are “single precision” floating point numbers and “double precision” floating point numbers that take up more memory space and are slower to handle, but which guarantee results with greater accuracy. The optimizer can decide which precision to adopt for a node or branch of the graph, for example as a function of the weight which the output image of this node or branch will have in subsequent computations. If this weight is dependent on parameters whose value is known by the optimizer when preparing the graph, then it is possible to guide the computations towards a given accuracy, depending on an acceptable error threshold optionally set by the user.
Optimization of user-defined arithmetic functions for relating certain filter parameters dependent to “high level” parameters linked to the thematic field of the texture. The optimizations used are related, for example, to the propagation of constants or the factorization of code common to multiple sub-expressions, and are not a salient feature of the proposed invention. It is the application of these techniques to the user-defined functions which is notable.
Identification of interdependencies between parameters exposed to the user and the output images. Each node situated downstream of a parameter is marked as being dependent on the latter. For output images, the list of parameters that potentially affect the appearance of the image, and for each parameter, the list of impacted intermediate images and output images, are thus obtained. To regenerate images as rapidly as possible when these parameters are modified, the list of all intermediate images used by an output image and affected by a change in the value of a parameter exposed to the user is stored independently. In this way, the rendering engine does not have to carry out the potentially expensive identification by itself and can simply consume the list prepared by the optimizer for this purpose, which accelerates the time taken for generating new result images corresponding to the new value provided by the host application.
Identification and propagation of sub-portions of the intermediate images used by the nodes that consume only a portion of their input image(s). Certain nodes use only a sub-portion of the input images. It is therefore possible to generate only this sub-portion without changing the final result. Knowledge of the parameters determining the areas used allows the optimizer to determine which sub-portions of the images of all nodes are actually useful. This information is stored for each node, which permits, when allowed by the parameters, the computation of only these sub-portions.

Many implementations of the optimizer component are possible, including all or part of the aforementioned functions.

The output of the optimization process consists of:
the list and description of the graph inputs and outputs;
the list and description of the numerical values used in arithmetic expressions of the dynamic parameters;
the list of composition nodes and for each of them:
the type of atomic operation used;
   the value of each numerical parameter (known value or expressed as a user-defined arithmetic expression interpreted by the generation engine);
   the region(s) of the output image to be computed;
   the list of user parameters influencing the node result.
the list of graph edges;
optimal sequencing of composition nodes (linearized graph);
potentially, other optimization information that can be used to accelerate the generation process.
   This data is saved in a binary format suitable for obtaining a file which is compact and can be rapidly read at the time of generation.

The rendering engine is responsible for the ordered execution of the computations in the list resulting from the optimizer. The computation nodes contained in the list provided by the optimizer may correspond to the nodes of the edit graph, to a subset of nodes in the edit graph reduced to a single node, or to an “implicit” node that does not exist in the original graph but is required to ensure consistent data flow (converting color images into black and white images, or vice versa, for example).

The engine statically incorporates the program to be executed for each filter of the above-described grammar, and for each computation inserted into the list, it will:
read the parameters used for the computation in question when the values are fixed;
evaluate the user functions for computing the value of the non-fixed parameters;
recover the memory locations of the intermediate results to be consumed for the computation of the current node;
perform the computation of the current node;
store the result image into memory.

Once the end of the list has been reached for a given result image, the rendering engine will deliver the image in question to the host application which will be able to use it.

The complexity of the rendering component is significantly reduced by the presence of the optimizer that loads upstream of the greatest possible number of steps implementing processing of high algorithmic complexity: linearization of the graph, detection of inactive subgraphs, optimization of user functions.

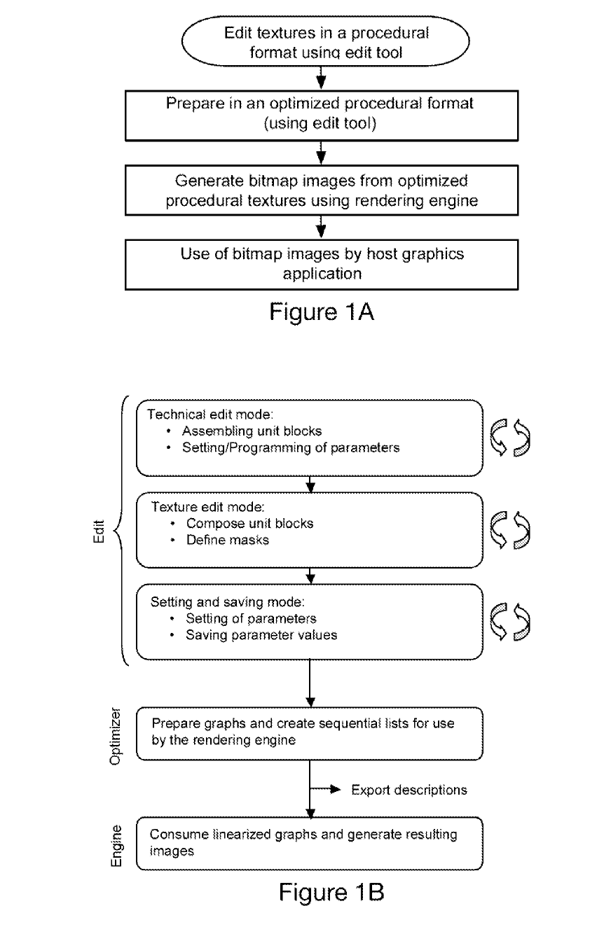

The overall method implemented by the various components of the proposed invention is illustrated in FIGS. 1A and 1B. The different steps are:

I. Assembling the filters into reusable blocks and setting/programming the filter parameters;
II. Composing the textures by means of reusable blocks/adjusting values of the exposed parameters/drawing masks and “regionalizing” the applied effects;
III. Setting the last exposed parameters/saving batches of values used;
IV. Exporting graphs reworked by the optimizer/saving description files;
V. Generating the result images with the rendering engine.

Within the editing tool, it is common to perform many iterations of stages I to III to obtain the desired graphics rendering. In addition, steps IV and V are executed at the time of each user manipulation to provide a visual rendering of the impact of the changes carried out.

Step IV is the point at which the editing tool and any host applications can be dissociated from each other. The description files created by the optimizer based on the edit graphs are the only data that are necessary for the host application to recreate the images designed by users of the editing tool.

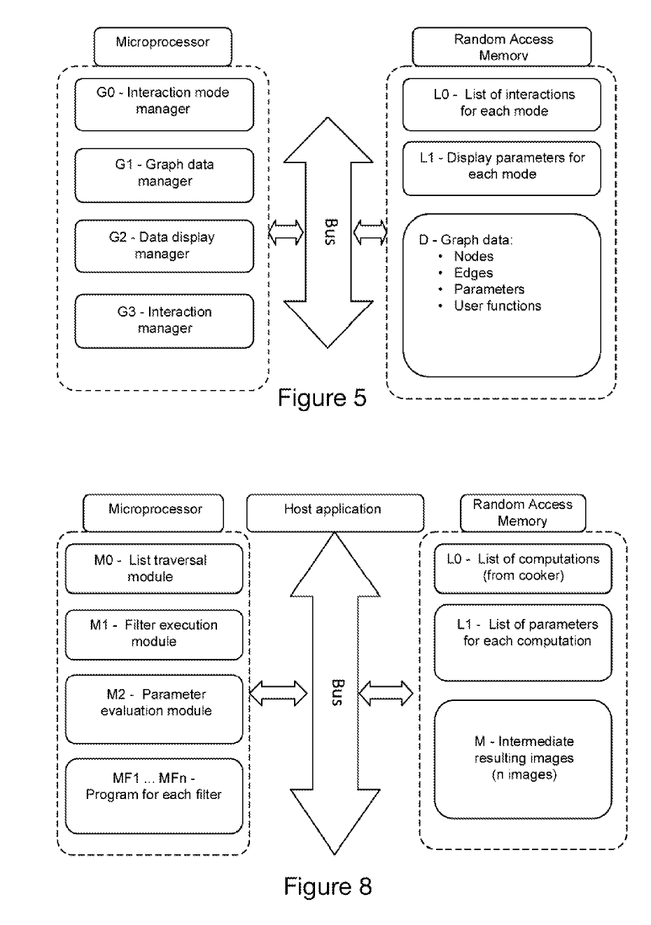

The editing tool of the proposed invention is implemented on a given device comprising a microprocessor (CPU) connected to a memory through a bus. An example of the implementation of this device is illustrated in FIG. 5.

The memory includes the following regions:
a memory L0, which stores the description of the different modes of interaction. This memory contains the list of authorized interactions for each mode of use, as well as the list of possible transitions between the different modes of interaction;
a memory L1, which stores the data display description for each mode of interaction. For example, this memory contains the description used for displaying the different overlays and different layers for the aforementioned intermediate display mode, or the description of the graph for the lowest-level display mode;
A memory D, which stores all of the graph data: nodes and edges, types of operation for each node, user-defined functions for the feedback control of certain parameters, a list of input images and output images.

The following different modules are hosted by the microprocessor:
a mode of interaction manager G0, which, depending on the current operating mode and possible transitions listed in L0, will trigger the transition from one edit mode to another;
a graph data manager G1, which will reflect the changes made by the user to any element of the graph onto the graph data D stored in memory: graph topology (nodes and edges), user functions, node parameters. The changes made to the graph data depend on the current mode of interaction;
a data display manager G2, which will build the representation of the graph being edited based on the data D, depending on the current mode of interaction and the display parameters, contained in L1, to be used for the current mode of interaction;
an interaction manager G3, which will allow or not allow alterations made by the user according to the current editing mode and the list of permitted interactions contained in L0.

This device provides for the multimode editing functions detailed above, by allowing users to edit the same data set in different modes, which each expose a set of possible interactions. FIG. 6 shows some of the steps involved in one approach whereby these different modes of interaction can be managed.

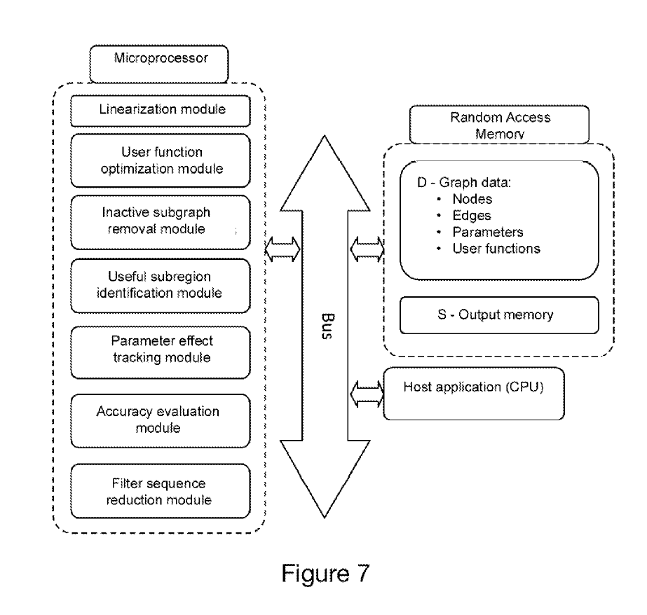

The graph preparation tool of the proposed invention (the optimizer) is implemented on a device comprising a microprocessor (CPU) connected to a memory through a bus. This device is illustrated in FIG. 7.

The RAM contains the following regions:
a region D, which contains all of the graph information once handled by the user:
the nodes and edges of the graph;
the parameters of each node;
the user-defined functions used to compute the value of certain node parameters from the values of other parameters;
a region S for receiving the description of the graph transformed into an ordered list of annotated nodes.

The following different modules are hosted by the microprocessor:
a graph linearization module;
a user function optimization module;
a module for removing non-connected or inactive subgraphs;
a module for identifying subregions to be computed for each node;
a parameter effect tracking module;
a module for evaluating the accuracy with which each filter can be computed;
a module for identifying and reducing filter sequences.

When optimizing a graph supplied by the editing tool, all or part of the various optimizer modules are enabled for processing the graph data contained in memory D. The representation in linearized sequential graph form is stored in memory S, so that it can be used immediately by the host application or stored in a file.

The rendering engine of the proposed implementation is implemented on a device comprising a microprocessor (CPU) connected to a memory through a bus. This device is illustrated in FIG. 8.

The RAM comprises the following regions:
a region L0, which stores the list supplied by the optimizer (linearized graph). This list can either be obtained directly by the optimizer in the case where the optimizer and the rendering engine are included within the same application (case of the editing tool, for example), or from a resource file embedded into the host application and assigned to the engine for the regeneration of the result images before use (usually in a graphical environment);
a region L1 ordered according to the computations contained in L0, and containing the parameter values to be used for each computation. For the parameters described in the form of arithmetic expressions, the expressions to be evaluated are also stored in this list;
a region M, which stores the intermediate results computed when traversing the list.
   This memory is used in particular to store intermediate results to be kept when computing filters that consume more than one input. The output images are also stored in this memory before being made available to the host application.

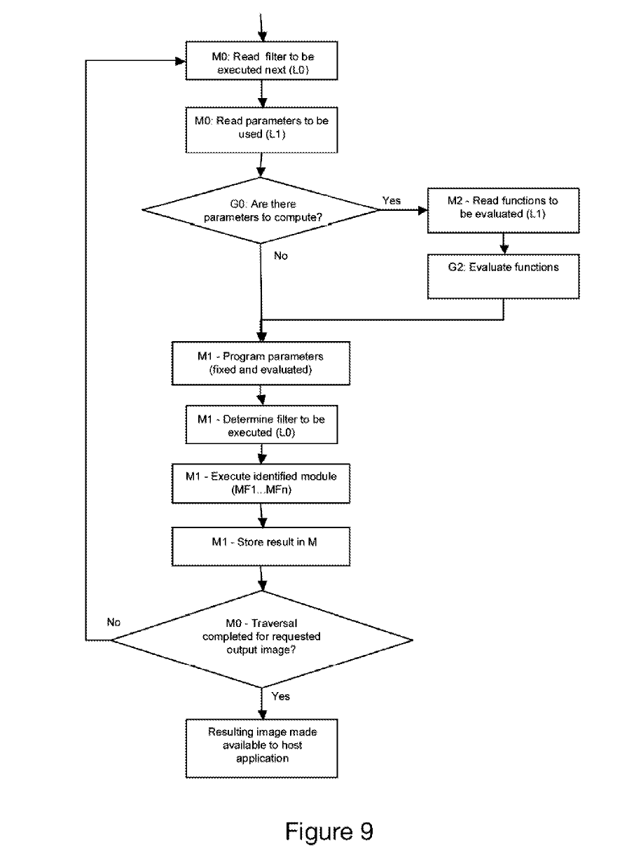

The microprocessor hosts the following modules:
a list traversal module M0, which will traverse the list contained in L0, and read the associated parameters from L1;
a module M1 which is responsible for the use of the correct values for each parameter of each filter and execution of the code of the filters contained in list L0;
a module M2 for evaluating user functions, implemented when the parameters do not have a fixed value, which is already in the list as a result of the preparation process. This is the module which will carry out the reading of the user-defined arithmetic expressions and the evaluation of these functions in order to generate the values of the parameters to be used during the execution of each filter;
a list of modules MF1 to MFn, each containing the code to be executed for a given filter. It is in this list of modules that module M1 will identify the filter to be executed, which corresponds to a particular position in list L0.
   FIG. 9 shows the key steps in the traversal by the rendering engine of the lists generated by the optimizer based on the edit graphs.

The proposed implementation of the present invention utilizes a number of filter categories, each comprising a number of filters. The grammar thus constituted is implementation-specific, and has been defined in order to obtain a satisfactory tradeoff between the expressiveness of said grammar and the complexity of the process of generating images based on reworked graphs. It is quite possible to consider different arrangements, with different categories and another selection of filters, which is derived, or is entirely disconnected from the selection of filters used in the implementation presented. The potential grammars must be known by the rendering engine, which must be able to perform the computations associated with each filter used or to convert the filters present in the employed grammar into filters or successions of equivalent filters for the correctness of the result image.

In the proposed implementation of the invention, the graph creation and editing tool exposes three operating modes, thus exposing different levels of complexity intended to be used by three different types of user. It is possible to envisage a different number of ways of using the editing tool, and therefore, to divide the tool user base in a different way.

Implementation of the various modules described above (e.g. the linearization, tracking, list traversal, filter execution, parameter evaluation modules, etc.) is advantageously carried out by means of implementation instructions, allowing the modules to perform the operation(s) specifically intended for the particular module. Instructions can be in the form of one or more pieces of software or software modules implemented by one or more microprocessors. The module and/or software is/are advantageously provided in a computer program product comprising a recording medium usable by a computer and comprising a computer readable program code integrated into said medium, allowing application software to run on a computer or another device comprising a microprocessor.

1. A system for editing and generating procedural textures comprising at least one microprocessor, a memory and a list of instructions, and allowing procedural textures in a procedural format to be edited, and, based on the edited procedural data, generating textures in a raster format, and further comprising:
an editing tool, adapted to provide a user interface for creating or modifying textures in a procedural format;
an optimization device, provided with a linearization module, a parameter-effect tracking module and a graph data module, for storing graph data in an optimized procedural format; and
a rendering engine, adapted to generate raster textures based on the graph data in an optimized procedural format and comprising a parameter list traversal module M0, a filter execution module M1, a parameter evaluation module M2 and a filter module, comprising the data to be executed for each of the filters.

2. The editing system according to claim 1, wherein the filters include data and mathematical operators.

3. A device for optimizing textures in a procedural format, comprising at least one microprocessor, a memory and a list of instructions, and further comprising:
a linearization module;
a parameter tracking module; and
a graph data module “D”.

4. The optimization device according to claim 3, integrated within a procedural texture editing device.

5. The optimization device according to claim 3, integrated within a rendering engine.

6. The optimization device according to claim 3, integrated within a third party application.

7. The optimization device according claim 3, wherein a specific and separate module stores the optimized data.

8. A rendering engine for rendering textures or images in a procedural format, comprising at least one microprocessor, a memory and a list of instructions, and further comprising:
a list traversal module M0 for traversing list of the processes to be performed;
a filter execution module M1;
a parameter evaluation module M2; and
a filter module, which includes the data to be executed for each of the filters.

9. The rendering engine for rendering textures or images in a procedural format according to claim 8, integrated within an application which includes at least one image generation phase, wherein said generation is performed based on graph data in an optimized procedural format.

10. A texture editing and generating method for a texture editing and generating system according to claim 1, comprising the steps of:
generating the graph data in a procedural format, using an editing tool; and
optimizing the generated data into graph data in an optimized procedural format, using an optimization device.

11. A procedural texture generating method for a rendering engine according to claim 8, comprising, for each filter involved, the steps of:
traversing the list of graph data in an optimized procedural format;
reading, from the graph data in a procedural optimized format, the parameters used for the computation performed for the fixed parameter values;
evaluating the user functions for computing the value of the non-fixed parameters;
recovering the memory locations of the intermediate results to be consumed in the computation of the current node;
performing the computation of the current data for graphs in an optimized procedural format for determining corresponding raster data;
storing the result image into memory; and,
when all of the filters involved have been processed, making the generated raster texture available to the host application.
